(19) United States
(12) Patent Application Publication
(10) Pub. No.: US 2012/0307870 A1
(43) Pub. Date: Dec. 6, 2012

(54) APPARATUS AND METHOD FOR COMMUNICATION

(75) Inventors: Sami-Jukka HAKOLA, Kempele (FI); Timo KOSKELA, Oulu (FI); Samuli TURTINEN, li (FI)

(73) Assignee: Renesas Mobile Corporation, Tokyo (JP)

(21) Appl. No.: 13/152,826

(22) Filed: Jun. 3, 2011

(51) Int. Cl. H04W 88/00

(52) U.S. Cl. 375/135; 375/136; 375/E01.033

(57) ABSTRACT

Apparatus and method for communication are provided. The solution comprises controlling a transmitter to map common and dedicated control channels on two frequency blocks and controlling the transmitter to transmit the frequency blocks utilising pair-wise frequency hopping on a shared spectrum.

### FIELD

The exemplary and non-limiting embodiments of the invention relate generally to wireless communication networks. Embodiments of the invention relate especially to an apparatus and a method in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

With the ever increasing demand for increasing data rates and higher quality services in the world of mobile communications comes ever increasing demand for better performance of cellular network infrastructures. The increased spectrum requirements due the increased data traffic drives operators seek offloading solutions for their traffic via local nodes providing local access to the Internet to prevent congesting own core network. A wide variety of diverse size of cells and connected devices are proposed in addition to traditional macro and microcells. However, the available frequency resources are limited and need for efficient use of the resources is essential.

Traditional solutions to improve spectrum efficiency cannot support the predicted data traffic in the future. Thus, operators, network and device manufacturers and other players in the field are considering the utilization of license-exempt (LE) or unlicensed frequency bands along with costly licensed spectrum. The LE spectrum can also be called as shared spectrum. Shared spectrum is only lightly regulated; users do not need licenses to exploit them. From the cellular traffic point of view, an interesting shared spectrum band opportunity is Industrial, Scientific and Medical (ISM) bands. The ISM bands are widely used for WLAN and Bluetooth® communication. The ISM bands allow both standardized systems and proprietary solutions to be deployed onto spectrum as far as regulations are followed. The regulations define maximum transmission powers and certain rules for the hopping based systems for the operation on the band.

Currently it is challenging to for many cellular systems such as the third and fourth generation systems long term evolution (LTE, known also as E-UTRA) and long term evolution advanced (LTE-A) to utilise ISM bands for example due to required continuous and synchronous resource allocation for control channels both in downlink and uplink transmission directions.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus in a communication system, comprising: at least one processor; and at least one memory including computer program code, the at least one memory and the computer program code configured to, with the at least one processor, cause the apparatus at least to perform: control a transmitter to map common and dedicated control channels on two frequency blocks; control the transmitter to transmit the frequency blocks utilising pairwise frequency hopping on a shared spectrum.

According to another aspect of the present invention, there is provided a method in a communication system comprising: controlling a transmitter to map common and dedicated control channels on two frequency blocks; controlling the transmitter to transmit the frequency blocks utilising pairwise frequency hopping on a shared spectrum.

According to an aspect of the present invention, there is provided an apparatus in a communication system, comprising: at least one processor; and at least one memory including computer program code, the at least one memory and the computer program code configured to, with the at least one processor, cause the apparatus at least to perform: control a receiver to receive common and dedicated control channels mapped to two frequency blocks utilising pair-wise frequency hopping on a shared spectrum.

According to another aspect of the present invention, there is provided a method in a communication system comprising: controlling a receiver to receive common and dedicated control channels mapped to two frequency blocks utilising pair-wise frequency hopping on a shared spectrum.

According to another aspect of the present invention, there is provided a computer program product embodied on a distribution medium readable by a computer and comprising program instructions which, when loaded into an apparatus, execute a computer process comprising: controlling a transmitter to map common and dedicated control channels on two frequency blocks and controlling the transmitter to transmit the frequency blocks utilising pair-wise frequency hopping on a shared spectrum.

According to yet another aspect of the present invention, there is provided a computer program product embodied on a distribution medium readable by a computer and comprising program instructions which, when loaded into an apparatus, execute a computer process comprising: controlling a receiver to receive common and dedicated control channels mapped to two frequency blocks utilising pair-wise frequency hopping on a shared spectrum.

### LIST OF DRAWINGS

Embodiments of the present invention are described below, by way of example only, with reference to the accompanying drawings, in which

FIG. 1 illustrates an example of a communication environment;

FIGS. 2A and 2B are flowcharts illustrating embodiments of the invention;

FIG. 3 illustrates an embodiment of the invention;

FIG. 4A illustrates an example of the shared spectrum;

FIG. 4B illustrates an example of the use of the pair-wise frequency hopping; and

FIGS. 5A and 5B illustrate examples of apparatuses applying embodiments of the invention.

### DESCRIPTION OF SOME EMBODIMENTS

Embodiments are applicable to any base station, user equipment (UE), server, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN or E-UTRAN), long term evolution (LTE, known also as E-UTRA), long term evolution advanced (LTE-A), Wireless Local Area Network (WLAN) based on IEEE 802.11standard, worldwide interoperability for microwave access (WiMAX), Bluetooth®, personal communications services (PCS) and systems using ultra-wideband (UWB) technology. IEEE refers to the Institute of Electrical and Electronics Engineers.

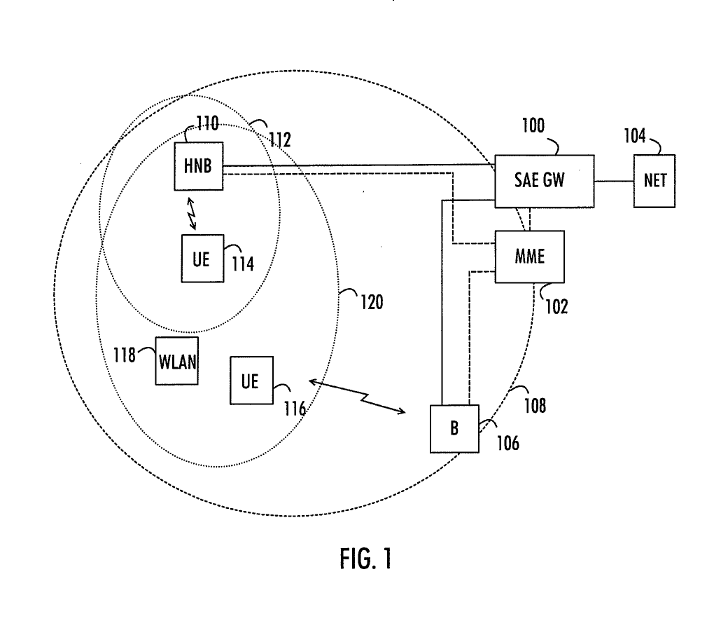

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

In the example of FIG. 1, a radio system based on LTE/SAE (Long Term Evolution/System Architecture Evolution) network elements is shown. However, the embodiments described in these examples are not limited to the LTE/SAE radio systems but can also be implemented in other radio systems.

The simplified example of a network of FIG. 1 comprises a SAE Gateway 100 and an MME 102. The SAE Gateway 100 provides a connection to Internet 104. FIG. 1 shows an eNodeB 106 serving a macro cell 108. In addition, a local area base stations or Home NodeB HNB 110 with a corresponding coverage area 112 is shown. In this example, the Home NodeB 110 and the eNodeB 106 are connected to the SAE Gateway 100 and the MME 102.

In the example of FIG. 1, user equipment UE 114 is camped on the HNB 110. The UE 116 is camped on the eNodeB 106. Furthermore, a wireless local area (WLAN) base station 118 is transmitting with a coverage area 120.

The eNodeBs (Enhanced node Bs) of a communication system may host the functions for Radio Resource Management: Radio Bearer Control, Radio Admission Control, Connection Mobility Control, Dynamic Resource Allocation (scheduling). The MME 102 (Mobility Management Entity) is responsible for the overall UE control in mobility, session/call and state management with assistance of the eNodeBs through which the UEs connect to the network. The SAE GW 100 is an entity configured to act as a gateway between the network and other parts of communication network such as the Internet for example. The SAE GW may be a combination of two gateways, a serving gateway (S-GW) and a packet data network gateway (P-GW).

User equipment UE refers to a portable computing device. Such computing devices include wireless mobile communication devices operating with or without a subscriber identification module (SIM), including, but not limited to, the following types of devices: mobile phone, smartphone, personal digital assistant (PDA), handset, laptop computer.

In an embodiment, at least some of the above connections between NodeB's and UEs utilise an unlicensed or shared spectrum which may be the same as the spectrum used by the WLAN base station 118.

The regulations applying to the usage of shared spectrum require different systems to use the available resources in a fair manner without causing excessive interference to other systems using the same resources.

In an embodiment, Listen-Before-Talk (LBT) or channel contention between the devices communicating on the shared spectrum is used to reduce interference. LBT or channel contention may require a device to listen, monitor or measure the usage of a channel for a given time before making the decision whether to transmit on the channel or not. In an embodiment, the device may monitor energy level on a channel and if the level is above a given threshold it may determine that the channel is in use by another device. If the channel or spectrum is used by another device the transmitter is configured to abstain from transmitting or select a different channel.

As most cellular systems require that control channel trans-missions are continuous and synchronous the restricted use of resources on shared spectrum is challenging as the resource allocation for control channels both in downlink and uplink transmission directions is problematic. In addition, if LBT type of channel access is utilized, the resource allocation for synchronization signals, critical control channel signalling like HARQ (Hybrid automatic repeat request) feedback is challenging as there is no certainty that resources for the required HARQ feedback for the earlier data transmission can be obtained.

In LTE based systems, dedicated and common control channels include Physical Broadcast Channel PBCH, Physical Control Format Indicator Channel PCFICH, Physical Downlink Control Channel PDCCH, Physical HARQ Indicator Channel PHICH, Physical Uplink Shared Channel PUSCH and synchronization signals.

As one skilled in the art is well aware embodiments of the invention are not limited to LTE based systems. The above channels and numerical values below are mentioned as a non-limiting example only.

In an embodiment, it is proposed to transmit dedicated and common control channels using frequency hopping. In LTE based systems, synchronization signals are currently transmitted among the symbols of Physical Downlink Shared Channel PDSCH. In an embodiment of the invention, the synchronization signals are transmitted in the control channel region utilizing frequency hopping. The regulations on ISM bands require maximum continuous frequency bandwidth for the hopping system to be less than 1 MHz and that the hopping system should hop pseudo-randomly between at least 15 non-overlapping frequency channels. As synchronization signals and PBCH on downlink require a 1.08 MHz bandwidth (6 Physical Resource Blocks PRB), the present LTE method of mapping control channels onto radio resources cannot be applied.

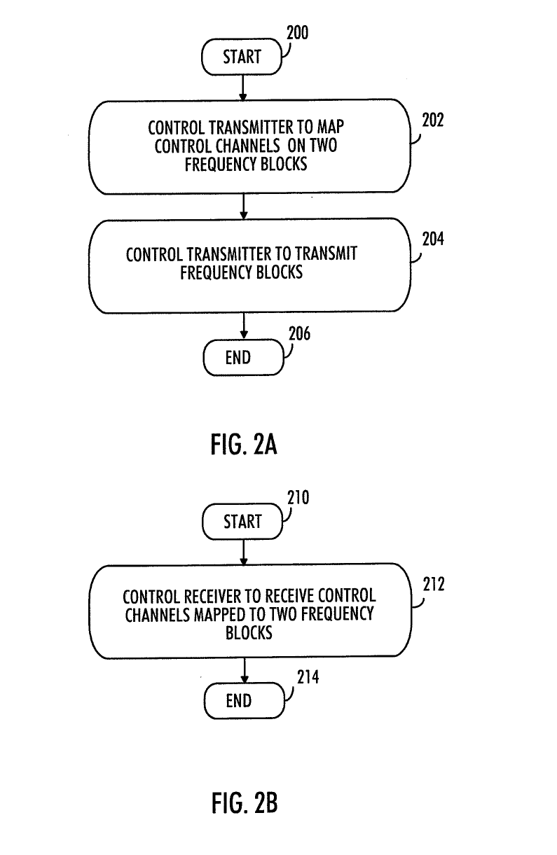

FIG. 2A is a flowchart illustrating an embodiment of the invention. The embodiment starts at step 200.

In step 202, a transmitter is controlled to map common and dedicated control channels on two frequency blocks.

In step 204, the transmitter is controlled to transmit the frequency blocks utilising pair-wise frequency hopping on a shared spectrum.

The process ends in step 206.

In an embodiment, it's proposed that control channel trans-mission on downlink and uplink utilize a pair-wise hopping of frequency pieces. In an embodiment when applying the embodiment to LTE based system, the bandwidth of the frequency blocks the control channels are mapped to could be three PRBs each. Three PRBs equal to 504 KHz and thus combining two pieces a virtual 6 PRB frequency chunk is obtained from which a receiver can construct a signal of 1.08 MHz bandwidth. Thus it could be possible to reuse LTE common channels in their current format mapped in discontinuous way onto subcarriers in frequency domain.

FIG. 2B is a flowchart illustrating an embodiment of the invention applied in a receiver. The embodiment starts at step 210.

In step 212, a receiver is controlled to receive common and dedicated control channels mapped to two frequency blocks utilising pair-wise frequency hopping on a shared spectrum.

The process ends in step 214.

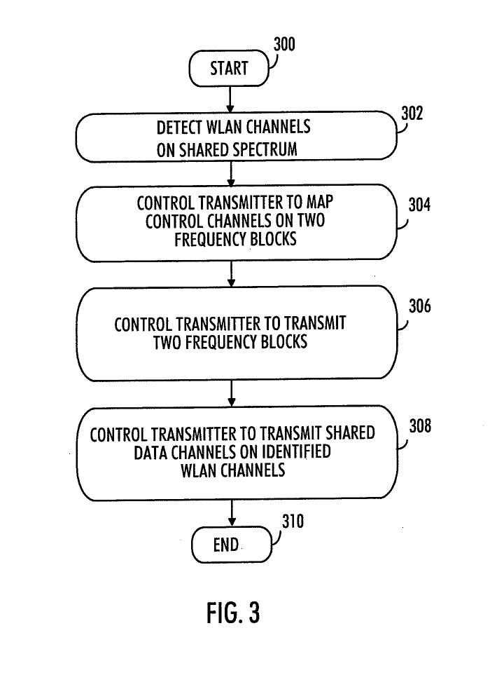

FIG. 3 is a flowchart illustrating an embodiment of the invention. The embodiment starts at step 300.

In step 302, a transceiver is controlled to detect and identify WLAN channels on given shared spectrum. The shared spectrum may be the ISM band on 2.4 or 5 GHz, for example. In an embodiment, downlink and uplink control channels are transmitted in frequency hopping way (continuously in time domain) between the identified WLAN channels. Shared data channels for both downlink and uplink could be transmitted using Listen-Before-Talk (LBT) on identified WLAN channels. In LTE based systems, the shared data channels are Physical Downlink Shared Channel PDSCH and Physical Uplink Shared Channel PUSCH.

In step 304, a transceiver is controlled to map common and dedicated control channels on two frequency blocks on a shared spectrum utilizing the frequency bands between the identified WLAN channels.

In step 306, the transceiver is controlled to transmit the frequency blocks utilising pair-wise frequency hopping utilizing the frequency bands between the identified WLAN channels Thus, the frequencies used in the transmission frequency blocks are hopping using the same hopping pattern. The hopping pattern may be a predefined pattern or one of a set of predefined hopping patterns. In general, the hopping patterns are defined by a base station or eNodeB or another network element of a communication system. When a UE is switched on it searches for control channels transmission of an eNodeB. When the UE finds a control channel transmitted by an eNodeB it may obtain information of the hopping pattern from the eNodeB.

For example in 2.4 GHz ISM band, there are three non-overlapping WLAN channels each using a bandwidth of 20/22 MHz. Taking into account a normal effective bandwidth of 83.5 MHz in 2.4 GHz ISM (in some countries, the 2.4 GHz ISM can utilize 100 MHz, and thus there are also 14 WLAN channels), it is possible to find resource at least for 15 non-overlapping frequency resources for the hopping control channel design. In addition, using the pair-wise hopping for the control channels and having hopping frequency of 1 ms (1 sub frame with two slots) allows a slot based hopping for PUCCH similar to current LTE based systems.

As mentioned above, in contrast to current LTE synchronization signals are not transmitted among the symbols of PDSCH, but in the control channel region utilizing the pair-wise hopping. In an embodiment, the hopping pattern and deployment of synchronization signals is designed so that the receiver (such as a UE) requiring the synchronization signals would not need to use the whole bandwidth of the ISM band to detect the synchronization signals in initial search phase of the LTE eNB on a ISM band. One option is to keep synchronization signals always in one region of the ISM band. The region may be the largest frequency region not used by the WLAN of the ISM band. For example, if the synchronization signals are transmitted every 5 ms, the hopping patterns may be so that control channel transmission takes place at least every 5 ms on certain resource region (the largest frequency region not used by the WLAN). E.g. when channels 1, 6 and 11 are used by a WLAN system, such largest frequency region would be from 2470 to 2480 MHz.

In step 308, the transceiver is controlled to transmit shared data channels using Listen-Before-Talk on identified WLAN channels. As described above, in Listen-Before-Talk a transceiver listens or measures the usage of a channel before making the decision whether to transmit on the channel or not. If the channel or spectrum is used by another device the transmitter is configured to abstain from transmitting or select a different channel. This way the transmission does not interfere with WLAN transmissions on the same channel.

The process ends in 310.

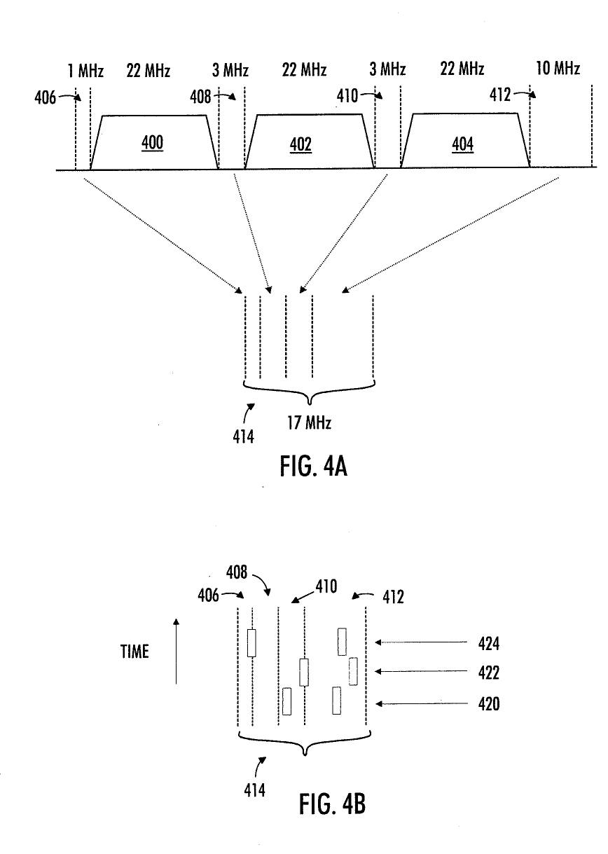

FIG. 4A illustrates an example of the shared spectrum. The figure shows WLAN channels on 2.4 GHZ ISM frequency band. Three WLAN channels 400, 402, 404 are illustrated. The channels may be identified as channels 1, 6 and 11. The numbering varies in different regions, however. Between the WLAN channels there are guard bands 406, 408, 410 and 412 which have bandwidths 1 MHz, 3 MHz, 3 MHz and 10 MHz, correspondingly.

In an embodiment, the common and dedicated control channels are mapped to two frequency blocks and transmit the frequency blocks utilising pair-wise frequency hopping on the frequency bands 406, 408, 410 and 412 which are between the WLAN channels. The frequency bands 406, 408, 410 and 412 form a 17 MHZ virtual frequency spectrum 414 which is utilised when transmitting the control channels both in downlink and uplink direction. In LTE-based systems, PUCCH is transmitted in the uplink direction and PDCCH, PCFICH, PHICH, PBCH and synchronization signals are transmitted in the downlink direction. The transmissions utilize Time Division Duplex TDD, where different transmission directions use the same frequency resources but are separated in time.

FIG. 4B illustrates an example of the use of the pair-wise frequency hopping of the control channels transmission on the shared spectrum. The control channels are mapped to two frequency blocks where the bandwidth of each frequency block is three PRBs corresponding to 504 KHz.

FIG. 4B shows a pair 420 of frequency blocks. The blocks are frequency hopping in time to positions 422 and 424 in the virtual frequency band 414. Only two first hopping positions are illustrated in FIG. 4B. In an embodiment, the synchronization signals are placed in a frequency block that is located in the largest region 412.

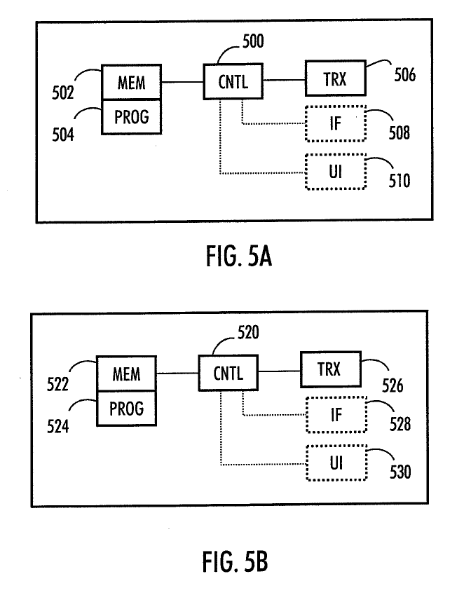

FIG. 5A illustrates an embodiment. The figure illustrates a simplified example of an apparatus applying embodiments of the invention. In some embodiments, the apparatus may be an eNodeB or user equipment of a communications system.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 500 configured to control at least part of the operation of the apparatus.

The apparatus may comprise a memory 502 for storing data. Furthermore the memory may store software 504 executable by the control circuitry 500. The memory may be integrated in the control circuitry.

The apparatus comprises a transceiver 506. The transceiver is operationally connected to the control circuitry 500. It may be connected to an antenna arrangement (not shown).

The software 504 may comprise a computer program comprising program code means adapted to cause the control circuitry 500 of the apparatus to control the transceiver 506 to map common and dedicated control channels on two frequency blocks and control the transceiver to transmit the frequency blocks utilising pair-wise frequency hopping on a shared spectrum.

The apparatus may further comprise interface circuitry 508 configured to connect the apparatus to other devices and network elements of communication system, for example to core. This applies especially if the apparatus is an eNodeB or a base station or respective network element. The interface may provide a wired or wireless connection to the communication network. The apparatus may be in connection with core network elements, eNodeB's, Home NodeB's and with other respective apparatuses of communication systems.

The apparatus may further comprise user interface 510 operationally connected to the control circuitry 500. The user interface may comprise a display, a keyboard or keypad, a microphone and a speaker, for example. This applies especially if the apparatus is user equipment or respective network element.

FIG. 5B illustrates an embodiment. The figure illustrates a simplified example of an apparatus applying embodiments of the invention. In some embodiments, the apparatus may be an eNodeB or user equipment of a communications system.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 520 configured to control at least part of the operation of the apparatus.

The apparatus may comprise a memory 522 for storing data. Furthermore the memory may store software 524 executable by the control circuitry 520. The memory may be integrated in the control circuitry.

The apparatus comprises a transceiver 526. The transceiver is operationally connected to the control circuitry 520. It may be connected to an antenna arrangement (not shown).

The software 524 may comprise a computer program comprising program code means adapted to cause the control circuitry 520 of the apparatus to control the transceiver 526 to receive common and dedicated control channels mapped to two frequency blocks utilising pair-wise frequency hopping on a shared spectrum. The transceiver may be configured to utilise more than one non-overlapping frequency bands in when receiving the two frequency blocks utilising pair-wise frequency hopping.

In an LTE based system, the bandwidth of the frequency blocks the control channels are mapped to could be three PRBs each. Three PRBs equal to 504 KHz. The transceiver 526 may be configured to receive frequency blocks and the software 524 may be control the apparatus to combine the two received frequency blocks and construct a signal of 1.08 MHz bandwidth. Thus it could be possible to reuse LTE common channels in their current format mapped in discontinuous way onto subcarriers in frequency domain.

The apparatus may further comprise interface circuitry 528 configured to connect the apparatus to other devices and network elements of communication system, for example to core. This applies especially if the apparatus is an eNodeB or a base station or respective network element. The interface may provide a wired or wireless connection to the communication network. The apparatus may be in connection with core network elements, eNodeB's, Home NodeB's and with other respective apparatuses of communication systems.

The apparatus may further comprise user interface 530 operationally connected to the control circuitry 520. The user interface may comprise a display, a keyboard or keypad, a microphone and a speaker, for example. This applies especially if the apparatus is user equipment or respective network element.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claim.

1. An apparatus in a communication system, comprising:
at least one processor; and
at least one memory including computer program code,
the at least one memory and the computer program code configured to, with the at least one processor, cause the apparatus at least to perform:
control a transmitter to map common and dedicated control channels on two frequency blocks; and
control the transmitter to transmit the frequency blocks utilising pairwise frequency hopping on a shared spectrum.

2. The apparatus of claim 1, the apparatus being configured to control the transmitter to transmit on shared data channels using Listen-Before-Talk.

3. The apparatus of claim 1, the apparatus being configured to control the transmitter to utilise more than one non-overlapping frequency resources when transmitting the two frequency blocks utilising pairwise frequency hopping.

4. The apparatus of claim 1, the apparatus being configured to map synchronisation signals to the two frequency blocks.

5. The apparatus of claim 1, the apparatus being configured to control the transmitter to utilise more than one non-overlapping frequency resources when transmitting the two frequency blocks utilising pair-wise frequency hopping, map synchronisation signals to the two frequency blocks and control the transmitter to transmit the synchronisation signals in the largest frequency resource.

6. The apparatus of claim 1, the apparatus being configured to identify wireless local area network channels of a given frequency band and control the transmitter to utilise frequency bands located between the identified wireless local area network channels in the transmission of the two frequency blocks.

7. The apparatus of claim 6, the apparatus being configured to control the transmitter to transmit shared data channels using Listen-Before-Talk on identified wireless local area network channels.

8. An apparatus in a communication system, comprising:
at least one processor; and
at least one memory including computer program code,
the at least one memory and the computer program code configured to, with the at least one processor, cause the apparatus at least to perform:
control a receiver to receive common and dedicated control channels mapped to two frequency blocks utilising pair-wise frequency hopping on a shared spectrum.

9. The apparatus of claim 8, the apparatus being configured to control the receiver to utilise more than one non-overlapping frequency bands in when receiving the two frequency blocks utilising pair-wise frequency hopping.

10. A method in a communication system, comprising:
controlling a transmitter to map common and dedicated control channels on two frequency blocks; and
controlling the transmitter to transmit the frequency blocks utilising pair-wise frequency hopping on a shared spectrum.

11. The method of claim 10, further comprising: controlling the transmitter to transmit on shared data channels using Listen-Before-Talk.

12. The method of claim 10, further comprising: controlling the transmitter to utilise more than one non-overlapping frequency resources when transmitting the two frequency blocks utilising pair-wise frequency hopping.

13. The method of claim 10, further comprising: mapping synchronisation signals to the two frequency blocks.

14. The method of claim 10, further comprising:
controlling the transmitter to utilise more than one non-overlapping frequency resources when transmitting the two frequency blocks utilising pairwise frequency hopping;
mapping synchronisation signals to the two frequency blocks; and
controlling the transmitter to transmit the synchronisation signals in the largest frequency resource.

15. The method of claim 10, further comprising: identifying wireless local area network channels of a given frequency band and controlling the transmitter to utilise frequency bands located between the identified wireless local area network channels in the transmission of the two frequency blocks.

16. The method of claim 15, further comprising: controlling the transmitter to transmit shared data channels using Listen-Before-Talk on identified wireless local area network channels.

17. A method in a communication system, comprising:
controlling a receiver to receive common and dedicated control channels mapped to two frequency blocks utilising pair-wise frequency hopping on a shared spectrum.

18. The method of claim 17, further comprising: controlling the receiver to utilise more than one non-overlapping frequency bands in when receiving the two frequency blocks utilising pair-wise frequency hopping.

19. A computer program product embodied on a distribution medium readable by a computer and comprising program instructions which, when loaded into an apparatus, execute a computer process comprising: controlling a transmitter to map common and dedicated control channels on two frequency blocks and controlling the transmitter to transmit the frequency blocks utilising pair-wise frequency hopping on a shared spectrum.

20. A computer program product embodied on a distribution medium readable by a computer and comprising program instructions which, when loaded into an apparatus, execute a computer process comprising: controlling a receiver to receive common and dedicated control channels mapped to two frequency blocks utilising pair-wise frequency hopping on a shared spectrum.
